(19) United States
(12) Patent Application Publication
(10) Pub. No.: US 2007/0016528 A1
(43) Pub. Date: Jan. 18, 2007

(54) System for processing data and method thereof

(76) Inventors: Wilhelmus Franciscus Johanne Verhaegh, Eindhoven (NL); Aukje Erna Maria Van Duijnhoven, Eindhoven (NL); Johannes Henricus Maria Korst, Eindhoven (NL); Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/567,209

(22) PCT Filed: Aug. 5, 2004
(86) PCT No.: PCT/IB04/51399

§ 371 Date: Feb. 3, 2006

(30) Foreign Application Priority Data
Aug. 8, 2003 (EP) 03077522.5

(51) Int. Cl. G06Q 99/00; H04L 9/00; H04K 1/00

(52) U.S. Cl. 705/50

(57) ABSTRACT

The invention relates to a method of processing data, the method comprising steps of enabling to (210) encrypt first data for a first source, and encrypt second data for a second source, (220) provide the encrypted first and second data to a server that is precluded from decrypting the encrypted first and second data, and from revealing identities of the first and second sources to each other, (230) perform a computation on the encrypted first and second data to obtain a similarity value between the first and second data so that the first and second data is anonymous to the second and first sources respectively, the similarity value. providing an indication of a similarity between the first and second data. The method may further comprise a step (240) of using the similarity value to obtain a recommendation of a content item for the first or second source. The first or second data may comprises a user profile or user ratings of content items. One of the applications of the method may be in collaborative filtering systems.

The invention relates to a system for processing data, the system comprising a first source having first data, a second source having second data, and a server. The invention further relates to a method of processing data and a server for processing data An information system comprising a plurality of user devices for storing user data expressing user preferences to media content, purchases, etc. is known. Such an information system typically comprises a server collecting the user data. The user data is analyzed for determining correlations between the user data, and providing a particular service to one or more users. For example, a collaborative filtering technique is a method for content recommendation that combines interests of a large group of users.

Memory-based collaborative filtering techniques are based on determining correlations (similarities) between different users, for which ratings of each user are compared to the ratings of each other user. These similarities are used to predict how much a particular user will like a particular piece of content. For the prediction step, various alternatives exist. Apart from determining the similarities between users, one may determine similarities between items, based on rating patterns received from the users.

A problem in this context is the protection of the privacy of the users, who don't want to reveal their interests to a server or to other users.

It is an object of the present invention to obviate the drawbacks of the prior art system, and provide a system for processing data, where the user privacy is protected. This object is realized in that the system comprises

a first source for encrypting first data, and a second source for encrypting second data,

a server configured to obtain the encrypted first and second data, the server being precluded from decrypting the encrypted first and second data, and from revealing identities of the first and second sources to each other,

computation means for performing a computation on the encrypted first and second data to obtain a similarity value between the first and second data so that the first and second data is anonymous to the second and first sources respectively, the similarity value providing an indication of a similarity between the first and second data.

In one embodiment of the present invention, the similarity value is obtained using a Pearson correlation or a Kappa statistic. In another embodiment, the computation means is realized using a Paillier cryptosystem, or a threshold Paillier cryptosystem using a public key-sharing scheme.

The computational steps required for determining the similarity value comprise a calculation of, for example, vector inner products and sums of shares. After the computation, encryption techniques are applied to the data to protect them. In a sense, this means that only encrypted information is sent to the server, and all computations are done in the encrypted domain.

In a further embodiment of the present invention, the first or second data comprises a user profile of a first or second user respectively, the user profile indicating user preferences of the first or second user to media content items. In another example, the first or second data comprises user ratings of respective content items.

An advantage of the invention is that user information is protected. The invention can be used in various kinds of recommendation services, such as music or TV show recommendation, but also medical or financial recommendation applications where the privacy protection may be very important.

The objection of the invention is also realized in that the method of processing data comprises steps of enabling to

encrypt first data for a first source, and encrypt second data for a second source,

provide the encrypted first and second data to a server that is precluded from decrypting the encrypted first and second data, and from revealing identities of the first and second sources to each other,

perform a computation on the encrypted first and second data to obtain a similarity value between the first and second data so that the first and second data is anonymous to the second and first sources respectively, the similarity value providing an indication of a similarity between the first and second data.

The method describes the operation of the system of the present invention.

In one embodiment, the method further comprises a step of using the similarity value to obtain a recommendation of a content item for the first or second source. For example, suppose we want to predict the score of an item i for active user a:
1. First, we compute the correlation between user a and every other user x. This is done by computing inner products between the rating vector of user a and each other user x, through an exchange via the server. In this way, user a knows the correlation value with each other user x=1,2, . . . , n, but he does not know who user 1,2, . . . , n is. On the other hand, the server knows who user 1,2, . . . , n is, but he doesn't know the correlation values.
2. Next, we compute a prediction for item i for user a by taking a kind of weighted average of the ratings of user 1,2, . . . , n for this item, where the weights are given by the correlation values. The procedure for this is that user a encrypts the correlation values and sends them to the server, who forwards them to the respective users 1,2, . . . , n. Each user x=1,2, . . . , n multiplies the encrypted correlation value he receives with the rating he gave for item i, and sends the result back to the server. The server, still not able to decrypt anything at all, then combines the encrypted products of the users 1,2, . . . , n into an encrypted sum, and sends this end result back to user a, who can decrypt it to get the desired result.

Claim 6 describes the operation of the system including the first and second sources, and the server. Claim 12 is directed to the operation of the server ensuring the user privacy and enabling the computation of the similarity value in the encrypted domain. Both claims are interrelated and directed to essentially the same invention.

These and other aspects of the invention will be further explained and described with reference to the following drawings:

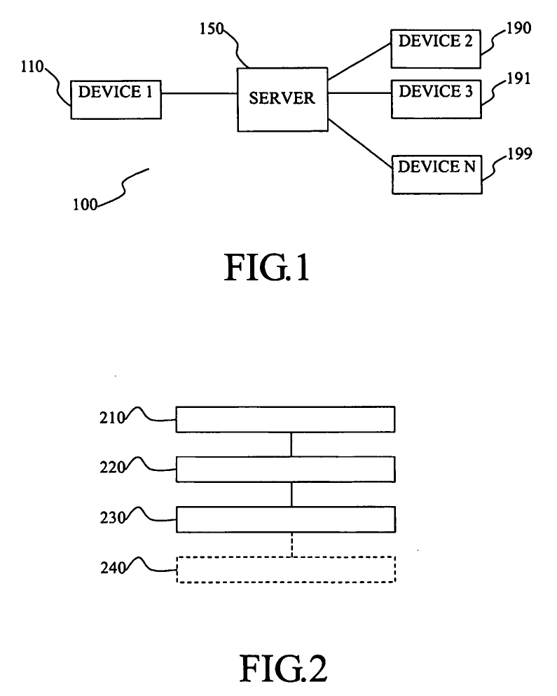

FIG. 1 is a functional block diagram of an embodiment of a system according to the present invention;

FIG. 2 is an embodiment of the method of the present invention.

According to an embodiment of the present invention, a system 100 is shown in FIG. 1. The system comprises a first device 110 (a first source), and a plurality of second devices 190, 191 . . . 199 (second sources). A server 150 is coupled to the first device and the second devices. The first device has first data, for example, user ratings of media content, or user preference data with respect to goods on sale, or medical records of a user indicating a prescription to give preference for certain food products, etc. The second device has second data, for example, the second data relate to preferences of a second user.

In one example, the first device is a TV set-top box arranged to store user ratings for TV programs. The first device is further arranged to obtain EPG data (Electronic Programme Guide) indicating, e.g., a broadcast time, a channel, a title, etc. of a respective TV program. The first device is arranged to store a user profile storing user ratings for respective TV programs. The user profile may not comprise ratings for all programs in the EPG data To determine whether a user will like a particular program which the user did not rate, various recommendation techniques can be used. For example, collaborative filtering techniques are used. Then, the first device collaborates with the second device storing the second data comprising a second user profile to find out whether the second profile is similar (using a similarity value) to the first profile and includes a rating of the particular program. If the similarity value between the first and second profiles is higher than a predetermined threshold, the rating included in the second profile is used to determine whether a user of the first device would like that particular program or not (a prediction step).

For instance, a kappa statistic or Pearson correlation may be used for determining the similarity measure between the first and second profiles.

The similarity may be a distance between two profiles, the correlation or a measure of the number of equal votes between two profiles. For the calculation of predictions, it is necessary that the similarities are high if users have the same taste, and low if they have an opposite taste. For example, the distance calculates the total difference in votes between the users. The distance is zero if the users have exactly the same taste. The distance is high if the users behave totally opposite. Therefore we have to do an adjustment such that the weights are high if the users vote the same. A simple distance measure is the known Manhattan distance.

In one example, if the second profile is sufficiently similar to the first profile (based on the similarity value), all content items (TV programs) not rated in the first profile but in the second profile are found. Said items are recommended to a user associated with the first profile. The recommendation may be based on the ratings of the items in the second profile, prediction methods for calculating predicted ratings of the items for the user of the first profile on the basis of the similarity value between the first and second profile, etc.

It should be noted that the similarity value can be used not only in the context of the collaborative filtering techniques (in the content recommendation field) but, generally, for a personalization of media content, a targeted advertising of users, matchmaking services, and other applications.

A problem of a user privacy arises because, in the prior art systems, the calculation of the similarity value requires that the first data of the first device and/or the second data of the second device are communicated to the second device and the first device respectively or the server.

The first device encrypts the first data, and the second device encrypts the second data The first and second data are sent to the server. The server is not capable of decrypting the encrypted first and second data Further, the server ensures that when the second device obtains the encrypted first data, the second device does not identify an identity of the first device. In turn, the first device cannot identify that the encrypted second data originate from the second device when the first device receives the second data Thus, the server is precluded from decrypting the encrypted first and second data, and from revealing identities of the first and second sources to each other.

For example, the server stores a database comprising a first identifier of the first device and a second identifier of the second device. When the first device transmits the encrypted first data to the second device via the server, the server strips away the first identifier attached to the encrypted first data, and the server delivers only the encrypted first data without the first identifier to the second device.

It should be noted that the computation on the encrypted first and second data may be performed in a number of alternative manners. For example, the first device encrypts the first data and sends the encrypted first data to the second device via the server. The second device calculates encrypted inner products between the first encrypted data and the second data. The second device sends the encrypted inner vector to the first device via the server. The first device decrypts the encrypted inner products, and calculates the similarity value between the first and second data. The first device obtains the similarity but the first device cannot identify the source of the second data.

Alternatively, the computations are performed completely on the server that has obtained the encrypted first data and the encrypted second data. In a further alternative, the computations are performed partly on the server and partly by the second device. The first device only decrypts the inner product and obtains the similarity value. Other alternatives can be derived.

FIG. 2 shows an embodiment of the method of the present invention. In step 210, first data for a first source are encrypted, and second data for a second source are encrypted. In step 220, the encrypted first and second data are provided to a server 150. The server is precluded from decrypting the encrypted first and second data, and from revealing identities of the first and second sources to each other. In step 230, a computation is performed on the encrypted first and second data to obtain a similarity value between the first and second data so that the first and second data is anonymous to the second and first sources respectively. The similarity value provides an indication of a similarity between the first and second data. Optionally, in step 240 the similarity value is used to obtain a recommendation of a content item for the first or second source. Further embodiments of the steps 210, 220, 230 and 240 are discussed in detail in the next paragraphs.

Methods exist for the following two problems:
1. Given two parties that each have a secret vector of integers, determine the inner product between the vectors without any of the parties having to reveal the specific information.
2. Given a set of parties that each have a secret number, determine the sum of the numbers without any of the parties having to reveal the number.

The first problem is solved, for example, by the Paillier cryptosystem. The second problem is handled by using a key-sharing scheme (also Paillier), where decryption can only be done if a sufficient number of parties cooperate (sad then only the sum is revealed, no detailed information).

Memory-Based Collaborative Filtering

Most memory-based collaborative filtering approaches work by first determining similarities between users, by comparing their jointly rated items. Next, these similarities are used to predict the rating of a user for a particular item, by interpolating between the ratings of the other users for this item. Typically, all computations are performed by the server, upon a user request for a recommendation,

Next to the above approach, which is called a user-based approach, one can also follow an item-based approach. Then, first similarities are determined between items, by comparing the ratings they have gotten from the various users, and next the rating of a user for an item is predicted by interpolating between the ratings that this user has given for the other items.

Before discussing the formulas underlying both approaches, we first introduce some notation. We assume a set U of users and a set I of items. Whether a user u ε U has rated item i ε I is indicted by a boolean variable bᵤᵢ, which equals one if the user has done so and zero otherwise. In the former case, also a rating rᵤᵢ, is given, e.g. on a scale from 1 to 5. The set of users that have rated an item i is denoted by Ui; and the set of items rated by a user u is denoted by Iᵤ.

The User-Based Approach

User-based algorithms are widely used collaborative filtering algorithms. As described above, there are two main steps: determining similarities and calculating predictions. For both we discuss commonly used formulas, of which we show later that they all can be computed on encrypted data.

Similarity Measures

Many similarity measures have been presented in the literature, for example, correlation measures, distance measures, and counting measures.

The well-known Pearson correlation coefficient is given by

$$s ( u , v ) = \frac{{\sum }_{i ∈ {I}_{u} ⋂ {I}_{v}} ( {r}_{ui} - {\overline{r}}_{u} ) ( {r}_{vi} - {\overline{r}}_{v} )}{\sqrt{{\sum }_{i ∈ {J}_{u} ⋂ {J}_{v}} {( {r}_{ui} - {\overline{r}}_{u} )}^{2} {\sum }_{i ∈ {J}_{u} ⋂ {J}_{v}} {( {r}_{vi} - {\overline{r}}_{v} )}^{2}}} \qquad ( 1 )$$

where r̅ᵤ denotes the average rating of user u for the items he has rated. The numerator in this equation gets a positive contribution for each item that is either rated above average by both users u and v, or rated below average by both. If one user has rated an item above average and the other user below average, we get a negative contribution. The denominator in the equation normalizes the similarity, to fall in the interval [−1;1], where a value 1 indicates complete correspondence and −1 indicates completely opposite tastes.

Related similarity measures are obtained by replacing r̅ᵤ in (1) by the middle rating (e.g. 3 if using a scale from 1 to 5) or by zero. In the latter case, the measure is called vector similarity or cosine, and if all ratings are non-negative, the resulting similarity value will then lie between 0 and 1.

Distance Measures

Another type of measures is given by distances between two users' ratings, such as the mean-square difference given by

$$\frac{{\sum }_{i ∈ {I}_{u} ⋂ {I}_{v}} {( {r}_{ui} - {r}_{vi} )}^{2}}{\vert {I}_{u} ⋂ {I}_{v} \vert} \qquad ( 2 )$$

or the normalized Manhattan distance given by

$$\frac{{\sum }_{i ∈ {I}_{u} ⋂ {I}_{v}} \vert {r}_{ui} - {r}_{vi} \vert}{\vert {I}_{u} ⋂ {I}_{v} \vert} \qquad ( 3 )$$

Such a distance is zero if the users rated their overlapping items identically, and larger otherwise. A simple transformation converts a distance into a measure that is high if users' ratings are similar and low otherwise.
Counting Measures

Counting measures are based on counting the number of items that two users rated (nearly) identically. A simple counting measure is the majority voting measure given by
s(u,v)=(2−γ)^{c}^{ᵤᵢ}γ^{d}^{ᵤᵥ} (4)
where 0<γ<1, cᵤᵥ=|{i ε Iᵤ∩Iᵥ|rᵤᵢ≈rᵥᵢ}| gives the number of items rated ‘the same’ by u and v, and dᵤᵥ=|Iᵤ∩Iᵥ|−cᵤᵥ gives the number of items rated ‘differently’. The relation ≈ may here be defined as exact equality, but also nearly matching ratings may be considered sufficiently equal.

Another counting measure is given by the weighted kappa statistic, which is defined as the ratio between the observed agreement between two users and the maximum possible agreement, where both are corrected for agreement by chance.

Prediction Formulas

The second step in collaborative filtering is to use the similarities to compute a prediction for a certain user-item pair. Also for this step several variants exist. For all formulas, we assume that there are users that have rated the given item; otherwise no prediction can be made.

Weighted sums. The first prediction formula we show is given by

$${\overline{r}}_{ui} = {\overline{r}}_{u} + \frac{{\sum }_{v ∈ {U}_{1}} s ( u , v ) ( {r}_{vi} - {\overline{r}}_{v} )}{{\sum }_{v ∈ {U}_{1}} \vert s ( u , v ) \vert} \qquad ( 5 )$$

So, the prediction is the average rating of user u plus a weighted sum of deviations from the averages. In this sum, all users are considered that have rated item i. Alternatively, one may restrict them to users that also have a sufficiently high similarity to user u, i.e., we sum over all users in Uᵢ(t)={v ε Uᵢ|s(u,v)≧t} for some threshold t.

An alternative, somewhat simpler prediction formula is given by

$${\hat{r}}_{vi} = \frac{{\sum }_{v ∈ {U}_{1}} s ( u , v ) {r}_{vi}}{{\sum }_{v ∈ {U}_{1}} \vert s ( u , v ) \vert} \qquad ( 6 )$$

Note that if all ratings are positive, then this formula only makes sense if all similarity values are non-negative, which may be realized by choosing a non-negative threshold.

Maximum Total Similarity.

A second type of prediction formula is given by choosing the rating that minimizes a kind of total similarity, as is done in the majority voting approach, given by

$${\hat{r}}_{ui} = arg {max}_{x ∈ X} {\sum }_{v ∈ {U}_{1}^{x}} s ( u , v ) \qquad ( 7 )$$

Where Uᵢ^{x}={v ε Uᵢ|rᵥᵢ≈X} is the set of users that gave item i a rating similar to value x. Again, the relation may be defined as exact equality, but also nearlymatching ratings may be allowed. Also in this formula one may use Uᵢ(t) instead of Uᵢ to restrict oneself to sufficiently similar users.
Time Complexity

The time complexity of user-based collaborative filtering is O(m²n) where m=|U| is the number of users and n=|I| is the number of items, as can be seen as follows. For the first step, a similarity has to be computed between each pair of users (O(m²)), each of which requires a run over all items (O(n)). If for all users all items with a missing rating are to be given a prediction, then this requires O(mn) (predictions to be computed, each of which requires sums of O(m) terms.

The Item-Based Approach

As mentioned, item-based algorithms first compute similarities between items, e.g. by using a similarity measure

$$s ( i , j ) = \frac{{\sum }_{u ∈ {U}_{i} ⋂ {U}_{j}} ( {r}_{ui} - {\overline{r}}_{u} ) ( {r}_{uj} - {\overline{r}}_{u} )}{\sqrt{{\sum }_{u ∈ {U}_{i} ⋂ {U}_{j}} {( {r}_{ui} - {\overline{r}}_{u} )}^{2} {\sum }_{u ∈ {U}_{i} ⋂ {U}_{j}} {( {r}_{uj} - {\overline{r}}_{u} )}^{2}}} \qquad ( 8 )$$

Note that the exchange of users and items as compared to (1) is not complete, as still the average rating ris subtracted from the ratings. The reason to do so is that this subtraction compensates for the fact that some users give higher ratings than others, and there is no need for such a correction for items. The standard item-based prediction formula to be used for the second step is given by

$${\hat{r}}_{ui} = {\overline{r}}_{i} + \frac{{\sum }_{j ∈ {I}_{u}} s ( i , j ) ( {r}_{vj} - {\overline{r}}_{j} )}{{\sum }_{j ∈ {I}_{u}} \vert s ( i , j ) \vert} \qquad ( 9 )$$

The other similarity measure and prediction formulas we presented for the userbased approach can in principle also be turned into item-based variants, but we will not show them here.

Also in the time complexity for item-based collaborative filtering the roles of users and items interchange as compared to the user-based approach, as expected. Hence, the time complexity is given by (O(mn²)) instead of (O(m²n)). If the number m of users is much larger than the number n of items, the time complexity of the item-based approach is favorable over that of user-based collaborative filtering.

Another advantage in this case is that the similarities are generally based on more elements, which gives more reliable measure. A further advantage of item-based collaborative filtering is that correlations between items may be more stable than correlations between users.

Encryption

In the next sections we show how the presented formulas for collaborative filing can be computed on encrypted ratings. Before doing so, we present the encryption system we use, and the specific properties it possesses that allow for the computation on encrypted data.

A Pubic-Key Cryptosystem

The cryptosystem we use is the public-key cryptosystem presented by Paillier. We briefly describe how data is encrypted.

First, encryption keys are generated. To this end, two large primes p and q are chosen randomly, and we compute n=pq and λ=1 cm(p-1;q-1). Furthermore, a generator g is computed from p and q (for details, see P. Paillier. Public-key cryptosystems based on composite degree residuosity classes. Advances in Cryptology-EUROCRYPT'99, Lecture Notes in Computer Science, 1592:223-238, 1999). Now, the pair (n;g) forms the public key of the cryptosystem, which is sent to everyone, and λ forms the private key, to be used for decryption, which is kept secret.

Next, a sender who wants to send a message mεZₙ={0,1, . . . , n−1} to a receiver with public key (n,g) computes a ciphertext ε(m) by
ε(m)=g^{m}rⁿmodn², (10)
where r is a number randomly drawn from Zₙ{x ε Z|0<x<nˆgcd(x,n)=1}.

This r prevents decryption by simply encrypting all possible values of m (in case it can only assume a few values) and comparing the end result. The Paillier system is hence called a randomized encryption system.

Decryption of a ciphertext c εm is done by computing

$$m = \frac{L ( {c}^{λ} mod {n}^{2} )}{L ( {g}^{λ} mod {n}^{2} )} mod n ,$$

where L(x)=(x−1)/n for any Q<x>n² with x≡1(modn). During decryption, the random number r cancels out.

Note that in the above cryptosystem the messages m are integers. However, rational values are possible by multiplying them by a sufficiently large number and rounding off. For instance, if we want to use messages with two decimals, we simply multiply them by 100 and round off. Usually, the range Zₙ is large enough to allow for this multiplication.

Properties

The above presented encryption scheme has the following nice properties. The first one is that
ε(m₁)ε(m₂)≡g^{m}^{₁}r₁ⁿg^{m}^{₂}r₂ⁿ≡g^{(m}^{₁}^{+m}^{₂}⁾(r₁r₂)ⁿ≡ε(m₁+m₂) (modn²),
which allows us to compute sums on encrypted data. Secondly,
ε(m₁)^{m}^{₂}≡(g^{m}^{₁}r₁ⁿ)^{m}^{₂}≡g^{m}^{₁}^{m}^{₂}(r₁^{m}^{₂})ⁿ≡ε(m₁m₂) (modn²),
which allows us to compute products on encrypted data. An encryption scheme with these two properties is called a homomorphic encryption scheme. The Paillier system is one homomorphic encryption scheme, but more ones exist. We can use the above properties to calculate sums of products, as required for the similarity measures and predictions, using

$${\prod }_{j}^{} {ɛ ( {a}_{j} )}^{{b}_{j}} ≡ {\prod }_{j}^{} ɛ ( {a}_{j} {b}_{j} ) ≡ ɛ ( {\sum }_{j} {a}_{j} {b}_{j} ) ( mod {n}^{2} ) . \qquad ( 11 )$$

So, using this, two users a and b can compute an inner product between a vector of each of them in the following way. User a first encrypts his entries aj and sends them to b. User b then computes (11), as given by the left-hand term, and sends the result back to a. User a next decrypts the result to get the desired inner product

Note that neither user a nor user b can observe the data of the other user; the only thing user a gets to know is the inner product.

A final property we want to mention is that
ε(m₁)ε(0)≡gⁿ^{₁}r₁ⁿg⁰r₂ⁿ≡g^{m}^{₁}(r₁r₂)ⁿ≡ε(m₁) (modn²).

This action, which is called (re)blinding, can be used also to avoid a trial-and-error attack as discussed above, by means of the random number r₂ ε Zₙ. We will use this further on.

Encrypted User-Based Algorithm

It is further explained how user-based collaborative filtering can be performed on encrypted data, in order to compute a prediction ^{\hat{r}}ui for a certain user u and item i. We consider a setup as depicted in FIG. 1, where the first device 110 (user u) communicates with the second devices 190, 191, 199 (other users v) through the server 150. Furthermore, each user has generated his own key, and has published the public part of it. As we want to compute a prediction for user u, the steps below will use the keys of u.

Computing Similarities on Encrypted Data

First we take the similarity computation step, for which we start with the Pearson correlation given in (1). Although we already explained how to compute an inner product on encrypted data, we have to resolve the problem that the iterator in the sums in (1) only runs over Iᵤ∩Iᵥ , and this intersection is not known to either user. Therefore, we first introduce

$${q}_{ui} = \{ \begin{matrix} {r}_{ui} - {\vec{r}}_{u} & if {b}_{ui} = 1 , i . e . , user u rated item i \\ 0 & otherwise ,\end{matrix}$$

and rewrite (1) into

$$s ( u , v ) = \frac{{\sum }_{i ∈ J} {q}_{ui} {q}_{vi}}{\sqrt{{\sum }_{i ∈ J} {q}_{ui}^{2} {b}_{vi} {\sum }_{i ∈ I} {q}_{vi}^{2} {b}_{ui}}}$$

The idea that we used is that any i∉Iᵤ∩Iᵥ does not contribute to any of the three sums because at least one of the factors in the corresponding term will be zero. Hence, we have rewritten the similarity into a form consisting of three inner products, each between a vector of u and one of v.

The protocol now rums as follows. First, user u calculates encrypted entries ε(qᵤᵢ),ε(qᵤᵢ²),ε(bᵤᵢ) for all i ε I, using (10), and sends them to the server, The server forwards these encrypted entries to each other user v₁, . . . , vₘ₋₁. Next, each user vⱼ, j=1, . . . , m−1, computes ε(Σ_{iεI}qᵤᵢqᵥ_{ⱼ}ᵢ),ε(Σ_{iεI}qᵤᵢ₂bᵥ_{ⱼ}), ε(Σ_{iεI}qᵥ_{ⱼ}ᵢ²bᵤᵢ) using (11), and sends these three results back to the server, which forwards them to user u. User u can decrypt the total of 3 (m−1) results and compute the similarities s(u,vⱼ), for all j=1, . . . , m−1). Note that user u now knows similarity values with the other m−1users, but he need not know who each user j=1, . . . , m−1) is. The server, on the other hand, knows who each user j=1, . . . , m−1) is, but it does not know the similarity values.

For the other similarity measures, we can also derive computation schemes using encrypted data only. For the mean-square distance, we can rewrite (2) into

$$\frac{{\sum }_{i ∈ {I}_{v} ⋂ {J}_{u}} ( {r}_{ui}^{2} - 2 {r}_{ui} {r}_{vi} + {r}_{vi}^{2} )}{\vert {I}_{u} ⋂ {I}_{v} \vert} = \frac{\begin{matrix}{\sum }_{i ∈ I} {r}_{ui}^{2} {b}_{vi} + 2 {\sum }_{i ∈ I} {r}_{ui} ( - {r}_{vi} ) + \\ {\sum }_{i ∈ I} {r}_{vi}^{2} {b}_{ui}\end{matrix}}{{\sum }_{i ∈ I} {b}_{ui} {b}_{vi}}$$

where we additionally define rᵤᵢ=0 if bᵤᵢ=0 in order to have well-defined values. So, this distance measure can also be computed by means of four inner products. The computation of normalized Manhattan distances is somewhat more complicated. Assuming the set of possible ratings to be given by X,; we first define for each rating xεX,

$${b}_{ui}^{x} = \{ \begin{matrix} 1 & if {b}_{ui} = 1 ⋀ {r}_{ui} = x \\ 0 & otherwise ,\end{matrix} \\ and \\ {a}_{vi}^{x} = \{ \begin{matrix} \vert {r}_{ui} - x \vert & if {b}_{ui} = 1 \\ 0 & otherwise ,\end{matrix}$$

Now, (3) can be rewritten into

$$\frac{{\sum }_{i ∈ J} {\sum }_{x ∈ X} {b}_{ ui}^{ x} {a}_{ vi}^{ x}}{{\sum }_{i ∈ j} {b}_{ui} {b}_{vi}} = \frac{{\sum }_{x ∈ X} {\sum }_{i ∈ J} {b}_{ui}^{x} {a}_{vi}^{x}}{{\sum }_{j ∈ J} {b}_{ui} {b}_{vi}}$$

So, the normalized Manhattan distance can be computed from |X|+1 inner products. Furthermore, a user v can compute
Π_{rεX}ε(Σ_{iεI}bᵤᵢ^{x}aᵥᵢ^{x})≡ε(Σ_{xεX}Σ_{iεI}bᵥᵢ^{x}aᵥᵢ^{x})
and send this result, together with the encrypted denominator, back to user u.

The majority-voting measure can also be computed in the above way, by defining

$${a}_{ui}^{x} = \{ \begin{matrix}1 & if {b}_{ui} = 1 ⋀ {r}_{ui} \approx x \\ 0 & otherwise ,\end{matrix} \qquad ( 12 )$$

Then, cᵤᵥ used in (4) is given by

$${c}_{uv} = {\sum }_{x ∈ X} {\sum }_{i ∈ I} {b}_{ui}^{x} {a}_{vi}^{x}$$

which can again be computed in a way as described above. Furthermore,

$${d}_{uv} = {\sum }_{i ∈ I} {b}_{ui} {b}_{vi} - {c}_{uv}$$

Finally, we consider the weighted kappa measure. Again, oᵤᵥ can be computed by defining

$${a}_{ui}^{x} = \{ \begin{matrix} w ( x , {r}_{ui} ) & if {b}_{vi} = 1 \\ 0 & otherwise ,\end{matrix}$$

and then calculating

$${a}_{uv} = \frac{{\sum }_{x ∈ X} {\sum }_{i ∈ I} {b}_{ ui}^{ x} {a}_{ vi}^{ x}}{{\sum }_{i ∈ I} {b}_{ui} {b}_{vi}}$$

Furthermore, εᵤᵥ can be computed in an encrypted way if user u encrypts pᵤ(x) for all xεX and sends them to each other user v, who can then compute

$${\prod }_{x ∈ X} {\prod }_{y ∈ X} ɛ ( v ( x ) ) \text{?}$$

$$\text{?} \text{indicates text missing or illegible when filed}$$

and send this back to u for decryption.

Computing Predictions on Encrypted Data

For the second step of collaborative filtering, user u can calculate a prediction for item i in the following way. First, we rewrite the quotient in (5) into

$$\frac{{\sum }_{v ∈ U} s ( u , v ) {q}_{vi}}{{\sum }_{v ∈ U} \vert s ( u , v ) \vert {b}_{vi}}$$

So, first user u encrypts s(u,vⱼ) and |s(u,vⱼ)| for each other user vⱼ j=1, . . . , m−1, and sends them to the server. The server then forwards each pair ε(s(u,vⱼ)),ε(|s(u,vⱼ)|) to the respective user vⱼ, who computes ε(s(u,vⱼ))^{q}^{ᵥⱼᵢ}ε(0)≡ε(s(u,vⱼ)qᵥ_{ⱼ}ᵢ) and ε(|s(u,vⱼ)|)^{b}^{ᵥⱼᵢ}ε(0)≡ε(|s(u,vⱼ)|bᵥ_{ⱼ}ᵢ) where he uses reblinding to prevent the server from getting knowledge from the data going back and forth to user vj by trying a few possible values. Each user vⱼ next sends the results back to the server, which then computes

$${\prod }_{j = 1}^{m - 1} ɛ ( s ( u , {v}_{j} ) {q}_{{v}_{j} i} ) = ɛ ( {\sum }_{j = 1}^{m - 1} s ( u , {v}_{j} ) {q}_{{v}_{j} i} )$$

$$and$$

$${\prod }_{j = 1}^{m - 1} ɛ ( \vert s ( u , {v}_{j} ) \vert {b}_{{v}_{j} i} ) = ɛ ( {\sum }_{j = 1}^{m - 1} \vert s ( u , {v}_{j} ) \vert {b}_{{v}_{j} i} )$$

and sends these results back to user u. User u can then decrypt these messages and use them to compute the prediction. The simple prediction formula of (6) can be handled in a similar way. The maximum total similarity prediction as given by (7) can be handled as follows.

First, we rewrite

$${\sum }_{v ∈ {U}_{i}^{x}} s ( u , v ) = {\sum }_{j = 1}^{m - 1} s ( u , {v}_{j} ) {a}_{{v}_{j} i}^{x}$$

where a^{x}, is as defined by (12). Next, user u encrypts s(u,vⱼ) for each other user vⱼ, j=1, . . . , m−1, and sends them to the server. The server then forwards each ε(s(u,vⱼ)) to the respective user vⱼ, who computes ε(s(u,vⱼ))^{a}^{ₓ}ᵥ_{ⱼ}ᵢε(0)≡εs(u,vⱼ)aᵥ_{ⱼ}ᵢ^{x}), for each rating xεX, using reblinding. Next each user vⱼ sends these |X| results back to the server, which then computes

$${\prod }_{j = 1}^{m - 1} ɛ ( s ( u , {v}_{j} ) {a}_{{v}_{j} i}^{x} ) = ɛ ( {\sum }_{j = 1}^{m - 1} s ( u , {v}_{j} ) {a}_{{v}_{j} i}^{x} )$$

for each xεX and sends the |X| results to user u. Finally, user u decrypts these results and determines the rating x that has the highest result.
Encrypted Item-Based Algorithm

Also item-based collaborative filtering can be done on encrypted data, using the threshold system of the Paillier cryptosystem. In such a system the decryption key is shared among a number 1 of users, and a ciphertext can only be decrypted if more than a threshold t of users cooperate. In this system, the generation of the keys is somewhat more complicated, as well as the decryption mechanism. For the decryption procedure in the threshold cryptosystem, first a subset of at least t+1 users is chosen that will be involved in the decryption. Next, each of these users receives the ciphertext and computes a decryption share, using his own share of the key. Finally, these decryption shares are combined to compute the original message. As long as at least t+1 users have combined their decryption share, the original message can be reconstructed.

The general working of the item-based approach is slightly different than the user-based approach, as first the server determines similarities between items, and next uses them to make predictions.

Compared to the known set-up of collaborative filtering, the embodiment of the implementation of the collaborative filtering, according to the present invention, requires a more active role of the devices 110, 190, 191, 199. This means that instead of a (single) server that runs an algorithm in the prior art, we now have a system running a distributed algorithm, where all the nodes are actively involved in parts of the algorithm. The time complexity of the algorithm basically stays the same, except for an additional factor |X| for some similarity measures and prediction formulas, and the fact that the new set-up allows for parallel computations.

Various computer program products may implement the functions of the device and method of the present invention and may be combined in several ways with the hardware or located in different other devices.

Variations and modifications of the described embodiment are possible within the scope of the inventive concept. For example, the server 150 in FIG. 1 may comprise the computation means to obtain an encrypted inner product between the first data and the second data, or encrypted sums of shares of the first and second data in the similarity value, and the server is coupled to a public-key decryption server for decrypting the encrypted inner product or the sums of shares and obtaining the similarity value. As another example, the general concept of the invention can be mapped in a variety of manners onto the value chain, i.e., on the business models of the interlinked commercial activities by different legal entities that in the end enable to provide a service to the consumer. An embodiment of the invention involves enabling a consumer to supply encrypted data and an identifier, representative of the consumer via a data network, e.g., the Internet. The relationship between the identifiers and the encrypted data of various consumers is broken in order to provide privacy. For example, a server substitutes another (e.g., temporary or session-related) identifier before passing on the encrypted data. The encrypted data of a consumer is then processed in the encrypted domain to calculate similarity values, either at a dedicated server or at another consumer, both being unable to decrypt the encrypted data.

The use of the verb ‘to comprise’ and its conjugations does not exclude the presence of elements or steps other than those defined in a claim. The invention can be implemented by means of hardware comprising several distinct elements, and by means of a suitably programmed computer. In the system claim enumerating several means, several of these means can be embodied by one and the same item of hardware.

A ‘computer program’ is to be understood to mean any software product stored on a computer-readable medium, such as a floppy-disk, downloadable via a network, such as the Internet, or marketable in any other manner.

1. A system (100) for processing data, the system comprising
a first source (110) for encrypting first data, and a second source (190, 191, 199) for encrypting second data,
a server (150) configured to obtain the encrypted first and second data, the server being precluded from decrypting the encrypted first and second data, and from revealing identities of the first and second sources to each other,
computation means (110, 150, 190, 191, 199) for performing a computation on the encrypted first and second data to obtain a similarity value between the first and second data so that the first and second data is anonymous to the second and first sources respectively, the similarity value providing an indication of a similarity between the first and second data.

2. The system of claim 1, wherein the second source comprises the computation means to
obtain an encrypted inner product between the first data and the second data, and
provide the encrypted inner product to the first source via the server,
the first source being configured to decrypt the encrypted inner product for obtaining the similarity value.

3. The system of claim 1, wherein the computation means is realized using a Paillier cryptosystem, or a threshold Paillier cryptosystem using a public key-sharing scheme.

4. The system of claim 1, wherein
the server comprises the computation means to obtain an encrypted inner product between the first data and the second data, or encrypted sums of shares of the first and second data in the similarity value, and
the server is coupled to a public-key decryption server for decrypting the encrypted inner product or the sums of shares and obtaining the similarity value.

5. The system according to claim 1, wherein the similarity value is obtained using a Pearson correlation or a Kappa statistic.

6. A method of processing data, the method comprising steps of enabling to
(210) encrypt first data for a first source, and encrypt second data for a second source,
(220) provide the encrypted first and second data to a server that is precluded from decrypting the encrypted first and second data, and from revealing identities of the first and second sources to each other,
(230) perform a computation on the encrypted first and second data to obtain a similarity value between the first and second data so that the first and second data is anonymous to the second and first sources respectively, the similarity value providing an indication of a similarity between the first and second data.

7. The method of claim 6, wherein the first or second data comprises a user profile of a first or second user respectively, the user profile indicating user preferences of the first or second user to media content items.

8. The method of claim 6, wherein the first or second data comprises user ratings of respective content items.

9. The method of claim 6, further comprising a step (240) of using the similarity value to obtain a recommendation of a content item for the first or second source.

10. The method of claim 9, wherein the recommendation is performed using a collaborative filtering technique.

11. A server (150) for processing data, the server being configured to
obtain encrypted first data of a first source (110) and encrypted second data of a second source (190, 191, 199), the server being precluded from decrypting the encrypted first and second data, and from revealing identities of the first and second sources to each other,
enable a computation on the encrypted first and second data to obtain a similarity value between the first and second data so that the first and second data is anonymous to the second and first sources respectively, the similarity value providing an indication of a similarity between the first and second data.

12. A method of processing data, the method comprising steps of
(220) obtaining encrypted first data of a first source (110) and encrypted second data of a second source (190, 191, 199) by a server (150), the server being precluded from decrypting the encrypted first and second data, and from revealing identities of the first and second sources to each other,
(230) enabling a computation on the encrypted first and second data to obtain a similarity value between the first and second data so that the first and second data is anonymous to the second and first sources respectively, the similarity value providing an indication of a similarity between the first and second data.

13. A computer program product enabling a programmable device when executing said computer program product to function as the system as defined in claim 1.
